(19) United States
(12) Patent Application Publication
(10) Pub. No.: US 2010/0294745 A1
(43) Pub. Date: Nov. 25, 2010

(54) Laser Machining Process and Apparatus

(75) Inventor: Stefano Cattaneo, Legnano (IT)

Correspondence Address: IPG PHOTONICS CORPORATION, 50 OLD WEBSTER ROAD, OXFORD, MA, 01540, US

(73) Assignee: IPG Photonics Corporation, Oxford, MA (US)

(21) Appl. No.: 12/469,416

(22) Filed: May 20, 2009

(51) Int. Cl. B23K 26/36

(52) U.S. Cl. 219/121.68; 219/121.72

(57) ABSTRACT

A method of thermally treating a surface of workpiece includes training a laser beam upon the surface and supplying a gaseous mixture to the surface. The mixture is configured with a process gas and at least one heat generating gas capable of having its molecules dissociate while generating an additional thermal energy which substantially raises the temperature of the surface.

### BACKGROUND OF THE DISCLOSURE

1. Field of the Disclosure

The disclosure relates to a process and apparatus for laser machining. In particular, the disclosure relates to a laser machining process and apparatus using an exothermic gas mixture for increasing the machining speed.

2. Prior Art Discussion

Laser manufacturing activities currently include cutting, welding, heat treating, cladding, vapor deposition, engraving, scribing, trimming, annealing, and shock hardening. Introduced long ago, laser cutting has undergone many changes including higher power levels and faster drive systems which have earned this technique reliability and, therefore, popularity. One of the changes includes the type of lasers. For many years only the CO₂ laser machining process was used for various applications. However, not only the requirements for higher powers and better quality of solid-state lasers continue to grow, but also, fairly recently, fiber lasers found their way into the industrial mainstream.

New developments in laser physics have enabled the construction of novel type of laser sources such as high-power fiber lasers, which have undergone a rapid development in the past years and could (not least due to its modular structure) be scaled from a few hundred Watts up to 50 kW and more. Adding to the above fiber lasers' energetic efficiency, considerable estimated lifetime and compact size, the fiber lasers might be and actually are a viable alternative to both conventional lamp- or diode-pumped Nd:YAG- as well as to CO2-Lasers.

Fiber laser processes operating at near infrared wavelengths are associated with relatively low temperatures than those associated with other types of laser sources, such as a CO2 laser source. Most of the times low temperatures are advantageous, but, sometimes, the excess of beat and the possibility of easily controlling the latter can improve process results and/or open the way to completely new applications. An example of process improvement is the highest cutting quality and cutting speed achievable; processing large surfaces, laser cladding or very deep laser welding or, again, laser welding with the possibility of controlling penetration depth and weld width.

A need therefore exists for an efficient machine process utilizing a laser source and characterized by elevated temperatures.

A further need exists for a device implementing the desired method.

### SUMMARY OF THE DISCLOSURE

In accordance with one aspect of the disclosure, a method satisfying the above-identified needs includes providing a gas mixture configured to generate additional heat once the surface of the object to be processed reaches a predetermined temperature. In particular, the gas mixture may preferably include one or more inert gases and acetylene.

The molecule of acetylene dissociates spontaneously at a certain temperature. The molecule dissociation is manifested by the generation of heat which, obviously, leads to much higher temperatures than those causing the dissociation. The elevated temperatures, as has been experimentally confirmed, substantially improve the efficiency of the cutting, cladding, welding and other processes.

In accordance with a further aspect of the disclosure, an apparatus implementing the above-disclosed method includes a fiber or solid-state laser source radiating light at the desired wavelength which is guided along a delivery fiber to a process head. The head is configured to tightly focus the laser light on the surface region to be processed.

To increase the temperatures associated with the laser machining process, the disclosed device further has a supplying unit configured to deliver a pressurized gas mixture to the surface region receiving the output laser light. To fully utilize the concept of the disclosed method, the gas mixture includes one or more inter or other process gases mixed up with a predetermined percentage of acetylene. Once the surface to be processed reaches a predetermined temperature, acetylene undergoes the dissociation process on the molecule level and generates additional energy. The disclosed device further includes a processing unit operative to control the desired percentage of acetylene necessary to obtain optimal results for a given process.

### BRIEF DESCRIPTION OF THE DRAWINGS

The above and other features and advantages of the disclosure will become more readily apparent from the following specific description in conjunction with the drawings in which:

FIG. 1 is a diagrammatic view of the disclosed device.

FIG. 2 is a flow chart illustrating the disclosed method.

FIG. 3 is an exemplary schematic of a fiber laser systems implemented in the device of FIG. 1.

### SPECIFIC DESCRIPTION

Reference will now be made in detail to the disclosed system. Wherever possible, same or similar reference numerals are used in the drawings and the description to refer to the same or like parts or steps. The drawings are in simplified form and are far from precise scale. For purposes of convenience and clarity only, the term “couple” and similar terms with their inflectional morphemes do not necessarily denote direct and immediate connections, but also include connections through mediate elements or devices.

The disclosed laser machining process and apparatus uses a gaseous medium capable of augmenting the temperatures caused by an output laser beam incident on the surface to be processed. In particular, the gaseous medium includes a controlled percentage of gas known to have the exothermic effect due to the dissociation of its molecules at or above the predetermined temperature. The thus generated thermal energy is added to the temperatures generated upon processing the surface by the output laser beam which improves the efficiency of the process. The temperature increase occurs not because of the increased laser output power, but due to the surface temperatures that create a thermal threshold necessary for the molecule dissociation of exothermic gases.

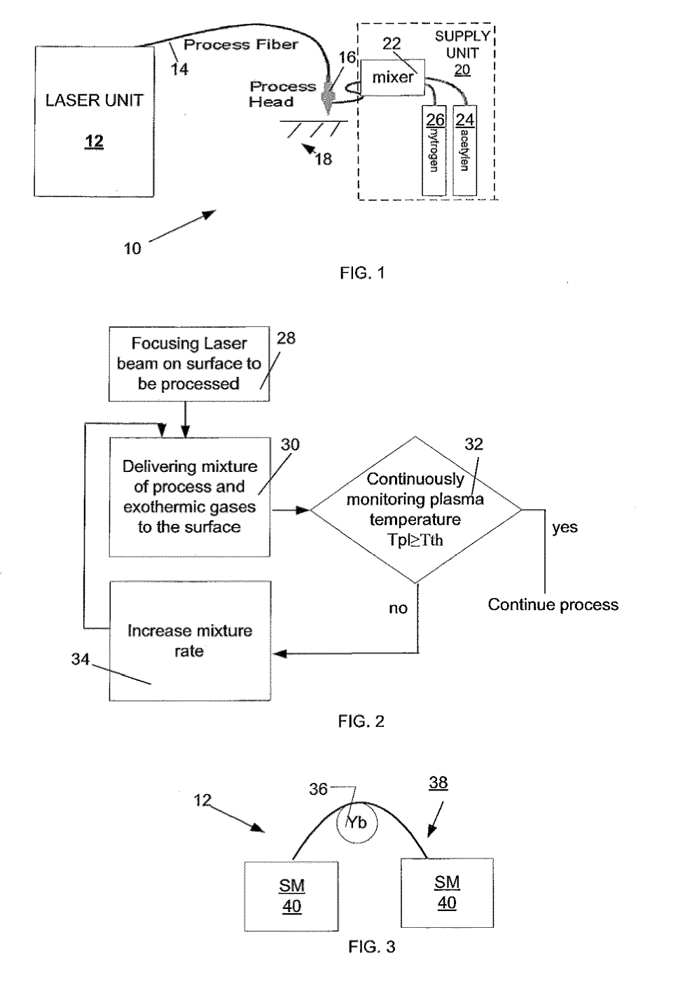

FIG. 1 illustrates a modular laser processing system 10. The system 10 is configured with a source of light, such a solid, CO₂ or fiber laser 12, lasing light at the desired near infrared wavelengths. The light is coupled into a process or delivery fiber 14 or bulk optics guiding the coupled light towards a process head 16 which is located in close proximity to a surface region 18 to be processed.

As the energy of the output laser beam is brought to a tight focal position, a gaseous medium is introduced so as to control a plasma ball at region 18. As known, plasma transfers heat more effectively than the laser beam does by itself The effective heat transfer is beneficial to the process since the processing speed, for example, cutting speed may be substantially increased with the elevated temperatures. In fact, increasing the cutting speed is often necessary to increase the system productivity.

The disclosed gaseous medium is composed of a process gas, such as inert gases, which may include, but not limited to nitrogen, argon, helium, and a combination of these. The inert gas used in laser processing processes is associated with a sublimation, or melting technique. Thus, processing with an inert gas is not a chemical process, it is a mechanical one.

Returning to FIG. 1, the process and exothermic gasses are stored under pressure in a supply unit 20 which may include a plurality of containers 24 and 26 for respective acetylene and process gases. The gasses may be further mixed in a mixer 22. Alternatively, supply unit 20 may include a single container replacing multiple containers 24 and 26 and mixer 22. Each of the gases may be distributed between multiple containers. Regardless of the specific configuration of supply unit 20, the mixture is delivered to metal surface region 18 to be processed though a cutting nozzle of head 16 or through process adductors, not shown but well known to one of ordinary skills in the art.

Referring to the mixture, the concentration of acetylene in the mixture is controlled. Typically, the addition of up to about 2% of acetylene to inert gases does not change the inert character of the latter. The amount of acetylene is important since it affects the process temperatures and cutting speeds. Different metals require different temperatures. The control of the acetylene concentration in the mixture can be easily implemented by monitoring and controlling plasma (or plume) temperatures with a detector 40.

Referring to FIG. 2 diagrammatically summarizing the above, the disclosed method includes focusing a laser beam at a surface in accordance with step 28. Either simultaneously with the above or upon a predetermined time, depending upon the profile of the surfaces, the type of the surface and, of course, the type of the process, the gas mixture is delivered to the surface, as shown in step 30. While delivering the gas mixture, a temperature of plume is continuously monitored, illustrated by step 32. If the temperature has not reached the desire threshold, the mixture rate is increased, as shown in step 34.

The following are the preliminary result achieved with the disclosed method and apparatus for different applications. For example, the disclosed gas mixture consisting of 1% of acetylene and 99% of nitrogen has been used in conjunction with a 1 kW fiber laser in a cladding process. In contrast to the same test but without acetylene, the porosity immediately disappeared due to the higher degree of fluidity of material, which in turn, was a result of elevated temperatures achieved by the disclosed process.

In a further example, a cutting test has been performed with the disclosed gas mixture. Compared to the standard stainless steel cutting process, which was performed only in the presence of nitrogen, the addition of only 1% of acetylene increased cutting speed at about 40% when used with a 2 kW fiber laser focused on a 3 mm thick sheet.

Preliminary tests have given the clear indication that Acetylene usage can give some improvements in material processing applications with laser sources in near infrared region, since just controlling mixture rate, it's possible to control process results in cutting, cladding and probably welding too.

Turning to FIG. 3, an exemplary welding system is configured with fiber laser source 12 including one or multiple amplifying cascades configured so that the output beam is substantially diffraction limited, i.e., a high quality beam, and can reach a power up to about 50 kW. In particular, fiber laser unit 12 is configured with one or more gain blocks 38 each having an active fiber (AF) with a gain medium doped by any of the known rare earth elements. The AF is formed with a MM core configured to propagate a fundamental mode without exciting higher modes and operative to lase an optical system output at a first wavelength. The gain block further has at least one or more pumping assemblies 40 each configured with a plurality of single mode fiber lasers. Each of the SM lasers of pump assembly 40 is operative to emit an optical pump output at a second wavelength shorter than the first wavelength.

A variety of configurations of SM pump fiber lasers 40 and AF can be used. For example, SM pump lasers each are an Yb fiber laser operative to generate the pump output at a wavelength of about 1000-1030 nm, whereas the AF is configured as an Yb doped fiber operative to generate the optical system output at a wavelength from about 1050 to about 1080 nm. In another example, SM pump fiber lasers 40 each are configured as Raman fiber laser generating the pump output at the wavelength varying between about 1480 and about 1510 nm. The AF is an Er-doped AF operative to generate the optical system output at the first wavelength of above about 1530 nm. Still a further configuration may include SM fiber lasers 40 each configured as an Yb/Er laser radiating output at the second wavelength between about 1530 and about 1540 nm. The AF, in this case, is preferably an Er doped fiber emitting the output at the first wavelength of about 1560-1600 nm. Alternatively, SM fiber lasers 40 is a combination Yb and Er emitting the pump output at the second wavelength of about 1550-1600 nm, whereas the AF, is a Tm doped fiber operative to lase the optical system output at the first wavelength in a range between about 1750-2100 μm. Still a further example includes SM pump fiber lasers 40 configured as a Nd doped fiber pumping at the second wavelength of about 920-945 nm. The recipient of the pump light in this example is an Yb doped fiber operative to lase the output at a wavelength in between about 974 nm-1 μm band.

The single mode fiber lasers with the configuration shown in FIG. 3 operate in either continuous wave or modulated modes at frequencies up to 50 kHz. The output is emitted from a SM fiber with a typical M²<1.07.

The foregoing description and examples have been set forth merely to illustrate the disclosure and arc not intended to be limiting. Accordingly, disclosure should be construed broadly to include all variation within the scope of the appended claims.

1. A method for laser machining, comprising:
training a laser output beam towards a surface of a workpiece, thereby heating the surface; and
providing a gaseous mixture including a process gas and a heat-generating gas capable, upon reaching a predetermined temperature by the surface, of an exothermic reaction to raise a surface temperature beyond the predetermined temperature.

2. The method of claim 1, wherein the heat-generating gas includes acetylene.

3. The method of claim 1, wherein the process gas is selected from the group consisting of argon, nitrogen and helium and a combination of these.

4. The method of claim 1, wherein training the laser output beam includes providing a laser selected from the group consisting of a solid state, CO₂ laser and fiber laser.

5. The method of claim 1, wherein providing the process gas and the heat-generating gas includes storing the gases in respective bottles.

6. The method of claim 1, wherein providing the process gas and the second gas includes storing the gases in a single bottle.

7. The method of claim 1, wherein training the laser output includes radiating a substantially single mode beam, the laser output having a power reaching about 20 kW.

8. The method of claim 1 further comprising monitoring the surface temperature.

9. The method of claim 8, wherein providing the gaseous mixture further includes controlling a rate at which the gaseous mixture is delivered to the surface in response to the monitored surface temperature.

10. A system for thermally treating a surface of a workpiece comprising:
a laser unit radiating an output beam trained towards the surface; and
a supply unit operative to deliver a gaseous mixture to the surface so as to produce a plasma, the gaseous medium being configured with a process gas and at a heat-generating gas, the heat-generating gas being capable of having molecules thereof dissociate at a predetermined temperature of the surface so as to produce an additional thermal energy raising the surface temperature above the predetermined temperature.

11. The system of claim 10, wherein the heat-generating gas includes acetylene.

12. The system of claim 10, wherein the process gas is selected from the group consisting of argon, nitrogen, helium and a combination of these.

13. The system of claim 11, wherein the supply unit includes a plurality of bottles, the process and heat-generating gases being stored separately in respective bottles.

14. The system of claim 11, wherein the supply unit includes a single bottle receiving the process and heat-generating gases.

15. The system of claim 14, wherein the supply unit further includes a mixer coupled to the plurality of bottles and operative to mix the process and heat-generating gases, the laser unit being provided with laser head coupled to the mixer.

16. The system of claim 15, wherein laser unit includes a laser head directly coupled to the single bottle.

17. The system of claim 10 further comprising a sensor operative to measure of the surface temperature, the supply unit being operative to controllably vary a rate at which the mixture is delivered to the surface in response to the measure surface temperature.

18. The system of claim 10, wherein the laser unit is selected from the group consisting of solid state lasers, CO₂ lasers and fiber lasers, the laser unit being configured with
a pump assembly, operative to generate a pump beam at a first wavelength, and
a gain block generating the output beam at a second wavelength greater than the first wavelength.

19. The system of claim 18, wherein gain block is configured with an active fiber selected from the group consisting of single-mode and multimode fiber, the active fiber being provided with a gain medium doped with a rare earth element which is selected from the group consisting of Yb, Er, Thulium and Neodymium and a combination of these.

20. The system of claim 19, wherein the multimode active fiber is configured with a core capable of supporting a fundamental mode at a predetermined wavelength, the active fiber being substantially losslessly coupled to a delivery fiber which delivers the output beam characterized by substantially the fundamental beam.
